(19) United States
(12) Patent Application Publication
(10) Pub. No.: US 2018/0023665 A1
(43) Pub. Date: Jan. 25, 2018

(54) Ferrule Retention

(71) Applicant: Bekaert Wire Ropes Pty Ltd, Sydney (AU)

(72) Inventors: Andrew Morgan, Whitebridge (AU); Wilfred de Sain, Valentine (AU); Hong Hui Sng, Cameron Park (AU)

(21) Appl. No.: 15/723,640

(22) Filed: Oct. 3, 2017

Related U.S. Application Data
(63) Continuation of application No. 14/306,800, filed on Jun. 17, 2014.
Application No. 14/306,800 is a continuation-in-part of application No. 14/354,696, filed on Apr. 28, 2014, now Pat. No. 9,599,191.

(30) Foreign Application Priority Data
Oct. 28, 2011 (AU) 2011904494
Jun. 7, 2013 (AU) 2013206219

(51) Int. Cl. F16G 11/10; F16B 21/10; F16B 2/14

(52) U.S. Cl. CPC F16G 11/10; Y10T 403/7039; F16B 2/14; F16B 21/10

(57) ABSTRACT

A locking assembly and a socket configured with the locking assembly, wherein the locking assembly is for axially locking a ferrule in a socket. The locking assembly has a block that is able to be positioned and secured in the socket adjacent to the opposing end of the ferrule. The locking block may be a drop-in locking block with a major face that abuts an end of the ferrule to secure it in the socket. The locking block may also have one of a trapezoidal prism, an elongate cam element, or transversely sliding block parts, each of which can abut an end of the ferrule to secure it in the socket.

### CROSS REFERENCE TO RELATED APPLICATIONS

This application is a continuation of U.S. patent application Ser. No. 14/306,800 filed Jun. 17, 2014 which is a continuation-in-part of U.S. patent application Ser. No. 14/354,696 filed Apr. 28, 2014, now issued as U.S. Pat. No. 9,599,191 B2, which is the United States national phase of International Application No. PCT/AU2012/001301 filed Oct. 25, 2012, which claims priority to Australian Patent Application No. 2011904494 filed Oct. 28, 2011, and this application further claims priority to Australian Patent Application No. 2013206219 filed Jun. 7, 2013, the disclosures of which are hereby incorporated in their entirety by reference.

### BACKGROUND OF THE INVENTION

### Field of the Invention

Disclosed is a locking assembly for locking a ferrule in a so-called socket. The ferrule to be locked in the socket can provide a termination of a wire rope. The ferrule may also have a configuration that facilitates its mating with the socket. The socket may, for example, form part of a dragline hoist and/or rigging assembly though is not limited to this application. In addition, the ferrule may terminate a dragline rope, for example, a dragline dump rope. It should be understood that the locking assembly can be employed with ferrules and sockets used with other wire ropes (including steel wire ropes) in a range of applications including but not limited to mining and civil engineering applications.

### Description of Related Art

Large capacity mining draglines subject a dragline bucket to enormous forces and loads. Ropes (also referred to as “cables”) are employed in draglines to control the various movements of the bucket, and accordingly experience extreme and rapid wear, especially at the sheaves in components of the dragline. For example, hoist ropes may need to be replaced every 3-6 months, drag ropes every 1-3 months and dump ropes every 1-2 weeks. Rope replacement is time consuming, with “downtime” of the dragline representing a significant cost in mining operations.

WO 2011/103640 to the present applicant discloses a method for attaching a ferrule to the end of a wire rope to finish that end and to facilitate its attachment to components (e.g. via a socket) in the dragline hoist and/or rigging assembly. The method of WO 2010/103640 can be employed to attach an example ferrule as disclosed herein to a wire rope.

Minimizing the rope changeover time can contribute to downtime reduction and improved operating cost and efficiency of a dragline. Sockets are accordingly employed to assist with rope connection to and disconnection from various components of a dragline rigging and hoist assembly. In this regard, a ferrule on the end of a wire rope can locate and be retained in such a socket.

Components of the forces and loads in draglines can be transferred to the wire ropes which may in turn cause the ferrule on a given rope to twist and/or be shunted (or to hammer) within an existing socket. However, with existing sockets, the resultant movement may not be prevented and/or the torque imparted to the ferrule may not be transferred to and absorbed or accommodated by the socket. This can quickly result in damage to or failure of the wire rope, ferrule and/or socket.

The above references to the background and prior art do not constitute an admission that such art forms a part of the common and/or general knowledge of a person of ordinary skill in the art. The above references are also not intended to limit the application of the ferrule and socket disclosed herein.

### SUMMARY OF THE INVENTION

Disclosed herein is a locking assembly for locking a ferrule attached to an end of a wire rope in a socket into which the ferrule can be received in use.

The locking assembly comprises a locking block that is able to be positioned and secured in the socket adjacent to the end of the ferrule. The locking assembly can function to prevent the ferrule from shifting or shunting forward in the socket in use, and so can prevent “hammering” of the ferrule in the socket and also ferrule fall out of the socket.

The ferrule may, for example, comprise an open end into which the end of the wire rope can be received for securement in the ferrule. The locking block may accordingly be positioned and secured in the socket adjacent to that end of the ferrule that opposes the open end. The ferrule, wire rope and socket may, for example, form part of the hoist and/or rigging of a dragline, but it should be understood that the locking assembly is not limited to this application.

The locking block comprises one of:

(i) a trapezoidal prism having a major face which in use is able to be positioned to engage the end of the ferrule to secure it in the socket;

(ii) an in-use transversely extending, elongate cam element which in use is able to be rotated such that an external surface of the cam element engages the end of the ferrule to secure it in the socket;

(iii) a major face which, when the locking block is received in the socket in use, faces the end of the ferrule to secure it in the socket;

(iv) in-use transversely extending first and second block parts which, when moved towards each other, are caused to be displaced towards and so as to engage with the end of the ferrule to secure it in the socket.

When the locking block may comprises a trapezoidal prism, a major face of the prism in use is able to be positioned to engage the end of the ferrule to secure it in the socket. For example, the trapezoidal prism may comprise angled faces on either side thereof which extend from the major face and converge to an opposing minor face. In use, each angled side face may be engaged by a respective lateral element that has a corresponding angled face. Thus, when the lateral elements are caused to be moved towards each other, their angled faces can respectively act on the angled side faces of the trapezoidal prism to cause the prism major face to be brought into engagement with the end of the ferrule, to thereby secure it in the socket.

When the locking block comprises an elongate cam element that extends transversely in the socket in use, the cam element is, in use, able to be rotated such that an external surface of the cam element can engage the end of the ferrule to secure it in the socket. For example, a bolt and the cam element may be mutually configured such that rotation of the bolt in the socket about the bolt's elongate axis causes the cam element to be rotated. Thus, the external surface of the cam element may be brought into engagement with the end of the ferrule to thereby secure it in the socket.

The elongate cam element may be provided with an external profile that is elliptical. In this case, the external surface of the cam element may be defined on ends of the ellipse as viewed in end profile. The external surface may extend for at least part (and typically for all) of the length of the cam element.

The cam element may also comprise a square-profiled elongate bore extending therethrough. Further, the bolt may comprise a length of its shank that is correspondingly (i.e. square) shaped to locate snugly within the bore. These matching profiles can enable a close mating of the bolt with the cam element when the bolt is rotated. It should be understood that other (e.g. other polygonal) profile shapes of the bore and shank can be employed.

A lug that defines a loop may project with respect to the end of the ferrule. For example, such a lug can provide for towing of a wire rope to which the ferrule is secured. The cam element may, in turn, be configured (e.g. sized and shaped) so as to be able to extend through the loop of the lug in use (i.e. when the ferrule is located in the socket.

When the locking block is in the form of a drop-in locking block (or plate), the locking block is provided with a major face which, when the locking plate is dropped into the socket in use, faces the end of the ferrule to secure it in the socket. For example, once the locking block has been dropped into the socket, a bolt may be adapted to extend from one side of the socket, though a hole at that side, through the aligned hole of the locking block and though an opposing hole at an opposite side of the socket to secure the locking block to the socket in use.

A retention pin may be provided to extend from a face opposite to the major face, through the locking block and into engagement with the bolt to secure the bolt to the locking block in use.

When the locking block comprises first and second block parts which extend transversely in the socket in use, the first and second block parts are configured such that, when moved towards each other, they are caused to be displaced towards and so as to engage with the end of the ferrule to secure it in the socket. For example, a bolt that passes through the socket can extend through a passage adjacent to the first and second block parts, whereby movement of the block parts towards each other causes them to engage the bolt and thereby be displaced towards the ferrule end.

The first and second block parts may be connected together by a nut and connector bolt whereby, when the nut is rotated in a given direction on the connector bolt, the first and second block parts are moved towards each other. The first and second block parts may each be provided with angled faces that each engage with a shank of the socket bolt. It is this engagement that may cause each block part to be displaced towards the end of the ferrule. Eventually, the first and second block parts are brought into engagement with the end of the ferrule to thereby secure it in the socket.

In one embodiment the locking assembly may further comprise a bolt for extending through aligned holes or passages of the locking block and socket. In this regard, the bolt may cooperate with the locking block to help secure the ferrule in the socket.

The ferrule that is secured by the locking assembly may be configured at or around at least one of its ends in a manner such that the ferrule is able to mate with a corresponding formation of the socket when received in the socket in use. This mating can help to prevent the ferrule from rotating or twisting within the socket when in use. This can, in turn, better allow torque that is transferred from the wire rope to the ferrule to be on-transferred to and absorbed or accommodated by the socket, and can extend the working life of the ferrule, wire rope end and socket.

In one embodiment, the ferrule may first be arranged in the socket in the mating engagement. The locking assembly may then be operable to secure the ferrule in the socket.

In one embodiment, the ferrule may be configured to mate with the corresponding formation of the socket for multiple rotational orientations of the ferrule around an elongate axis of the ferrule.

In one embodiment, the locking block may be configured to be positioned and secured in the socket adjacent to a component that is secured to the end of the ferrule. This component may, for example, provide for the afore-mentioned mating with the corresponding socket formation. This component may, for example, have a polygon-shaped or U-shaped profile.

Further, at least two opposing sides of the profile may be configured to mate with a corresponding formation in the socket in use. The polygon-shaped profile of the component may be provided with an even number of sides. The distance between opposing sides in the polygon- or U-shaped profile may be equal to or greater than a diameter of the adjacent ferrule end, so that the component rather than the ferrule interacts with the socket facing surfaces.

In one embodiment, the component may be provided with a tow lug to enable towing and handling of the rope to which the ferrule is secured. The tow lug may be affixed or releasably secured to the component. For example, once the ferrule has been located in the socket, the tow lug may be released therefrom, and the locking assembly may then be positioned in the socket.

The interaction of the component sides with the socket can allow torque that is transferred from the wire rope to the ferrule to be on-transferred to and absorbed or accommodated by the socket to extend the working life of the ferrule, wire rope end and socket.

Also disclosed herein is a socket configured for use with a locking assembly as set forth above. As mentioned above, the socket may form part of a dragline hoist and/or rigging assembly.

Also disclosed herein is a method of securing a ferrule in a socket. The method comprises locating the ferrule so as to mate with the corresponding formation of the socket. The method also comprises securing the ferrule against axial movement within the socket using a locking assembly as set forth above.

Also disclosed herein is a system for securing a ferrule in a socket. The system comprises a socket and a ferrule, with the socket comprising a corresponding formation to mate with the ferrule. The system also comprises a locking assembly as set forth above.

### BRIEF DESCRIPTION OF THE DRAWINGS

Notwithstanding any other forms which may fall within the scope of the locking assembly, socket and method as set forth in the Summary, specific embodiments will now be described, by way of example only, with reference to the accompanying drawings in which:

FIG. 1 shows a perspective view of a first embodiment of a locking assembly for locking a ferrule (including a component secured to a distal end of the ferrule) against axial movement in a socket, the ferrule being secured to an end of a wire rope;

FIGS. 2A to 2C respectively show partly sectioned side, side and end views of the locking assembly, ferrule and component of FIG. 1;

FIGS. 3A1-3C2 respectively show front and side views of parts of the locking assembly, and the component, of FIGS. 1 and 2;

FIG. 4 shows a perspective view of the locking assembly of FIGS. 1 to 3 located in a cavity of a socket, the locking assembly locking the ferrule and component against axial movement in the socket;

FIG. 5 shows a sectional perspective view through the socket of FIG. 4, showing the component at the end of the ferrule and its interaction with the socket;

FIG. 6 shows a perspective view of a ferrule secured to an end of a wire rope, illustrating a socket mating formation at a proximal end of the ferrule;

FIGS. 7 and 8 respectively show sectional side and end views through the ferrule of FIG. 6 prior to it being attached (e.g. die-pressed) to a wire rope end;

FIG. 9 shows a sectional perspective view through a socket with the ferrule of FIG. 6 located therein, to illustrate the ferrule and its interaction with the socket;

FIG. 10 shows a perspective view of a ferrule prior to being secured to an end of a wire rope, to illustrate an alternative socket mating formation at a proximal end of the ferrule;

FIG. 11 shows a sectional perspective view through a socket with the ferrule of FIG. 10 attached to a wire rope and located in the socket, to illustrate the ferrule and its interaction with the socket;

FIG. 12 shows a perspective view of a ferrule secured to an end of a wire rope, with an alternative formation secured at a distal end of the ferrule;

FIGS. 13A to 13J show various views of a second embodiment of a locking assembly for locking a secured component of a ferrule against axial movement in a socket;

FIGS. 14A to 14C respectively show perspective, side and plan views of the locking assembly of FIG. 13 in use in a socket, the assembly being used to lock the ferrule against axial movement in the socket, the ferrule being secured to an end of a wire rope;

FIGS. 15A1, 15A2, 15B, 15C, and 15D show various views of a third embodiment of a locking assembly for locking a secured component of a ferrule against axial movement in a socket;

FIGS. 16A to 16E show various views of a fourth embodiment of a locking assembly for locking a secured component of a ferrule against axial movement in a socket;

FIGS. 17A to 17E show various views of a modified plate for location at an end of a ferrule, the plate comprising a lifting and towing lug arranged thereat; and

FIG. 18 shows another modified plate for location at an end of a ferrule, the plate comprising a mounting point for a lifting and towing eyebolt.

### DESCRIPTION OF THE INVENTION

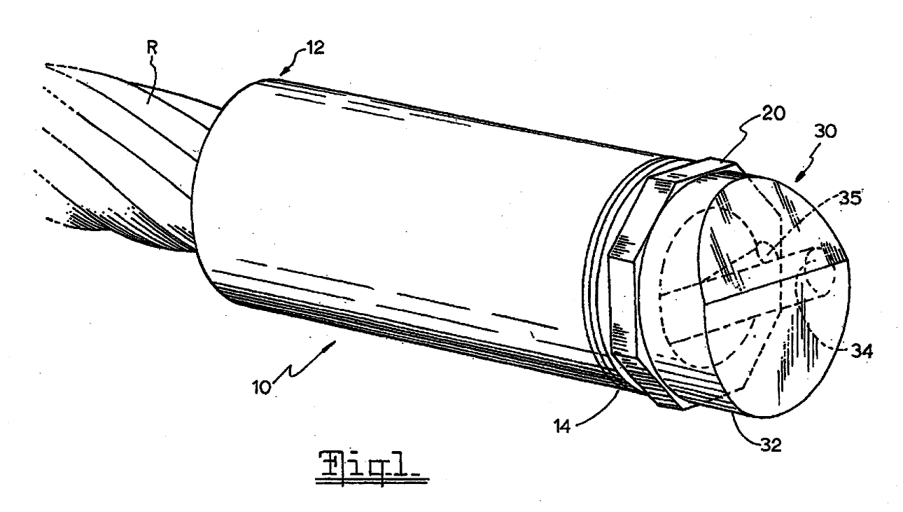

Referring firstly to FIGS. 1 to 5 a ferrule 10 is shown for attachment to an end of a wire rope R. The wire rope may, for example, be employed in a dragline (e.g. as part of the hoist and/or rigging of the dragline) but is not limited to this application. The socket in which the ferrule is to be located can also form part of a dragline hoist and/or rigging assembly.

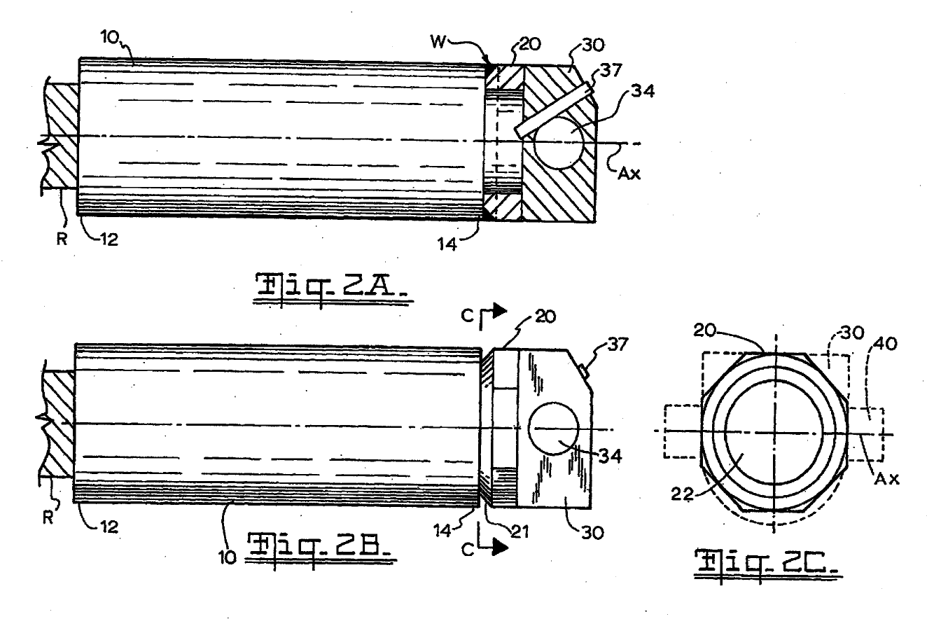

The ferrule 10 comprises an open proximal end 12 into which the end of the wire rope R can be received for securement in the ferrule (e.g. secured via the die-pressing method of WO 2011/103640). The ferrule 10 also comprises an opposing distal end 14 (i.e. that opposes the proximal end 12). An axis Ax of the ferrule 10 (FIG. 2) extends between the proximal and distal ends 12, 14.

In FIGS. 1 to 5, the ferrule 10 is configured around the distal end 14 to mate (e.g. abut or closely face) with a socket 50. The socket 50 may be unmodified, whereby the ferrule 10 is modified and configured to a pre-existing cavity 51 within the socket so as to mate therewithin in use. Alternatively, the socket 50 may be modified, such as by providing it with a modified cavity 51 into which the ferrule 10 can be received for mating in use.

In either case, this mating engagement functions to stop the ferrule from rotating or twisting within the socket in use, thereby allowing torque that is transferred from the wire rope R to the ferrule to be better on-transferred to and absorbed or accommodated by the socket. This can extend the working life of each of the ferrule, wire rope end and socket.

In addition, the ferrule 10 may be configured around the distal end 14 so that it is able to mate with the socket 50 at a given one of a number of rotational orientations of the ferrule around its axis Ax. Thus, the wire rope need not be rotated, twisted or unrolled to any significant extent to enable the ferrule to be easily and correctly located in the socket cavity.

This is to be contrasted with the distal ferrule lug of WO 2011/103640 which can only be pinned in the socket in one orientation, something which can be quite problematic out in the field of use.

In FIGS. 1 to 5, to configure the distal end 14 of the ferrule 10, a component in the form of a key-in plate 20 is secured (e.g. welded) to the distal end 14. The plate 20 enables torque that is transferred from the wire rope to the ferrule to be on-transferred to and absorbed or accommodated by the socket. An edge of the plate 20 may be chamfered 21 at the surface that faces in to the distal end 14 to be secured thereto. This chamfer can allow for the plate 20 to be welded W (FIG. 2A) onto the distal end of the socket whereby the weld W does not need to protrude beyond the plate by any significant extent. The weld W may extend circumferentially around the plate 20, or comprise discrete weld regions.

The plate 20 can be provided as a solid plate that is suitably drilled at its inside face (i.e. the face that secures to the distal end 14 of ferrule 10 in use) to enable the plate 20 to be friction or interference fit to the ferrule end 14 (e.g. to be tapped onto the ferrule end 14 with a suitable tool such as a hammer).

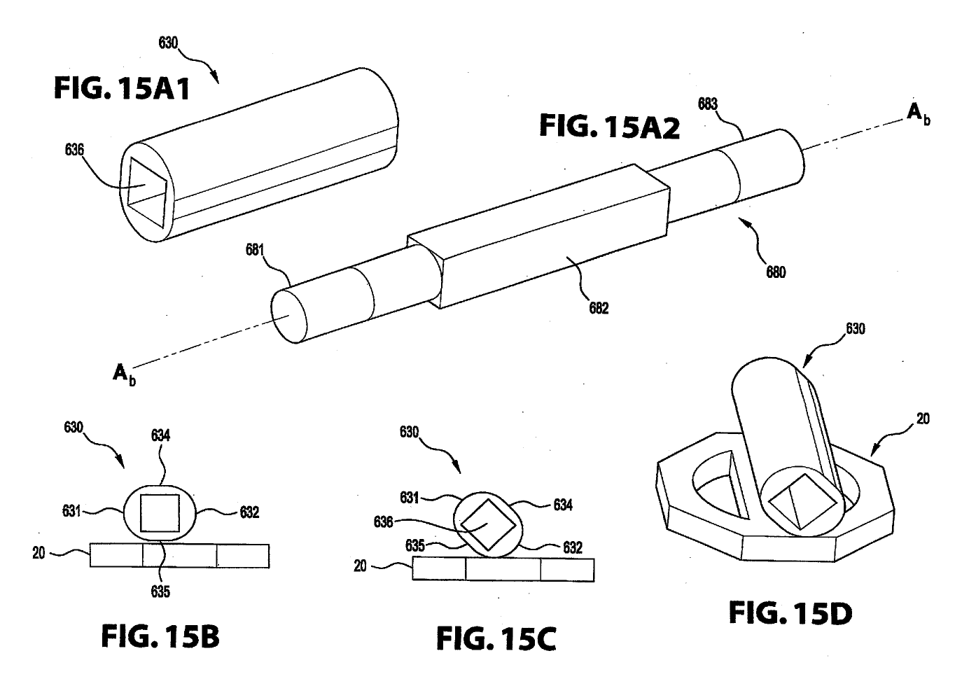

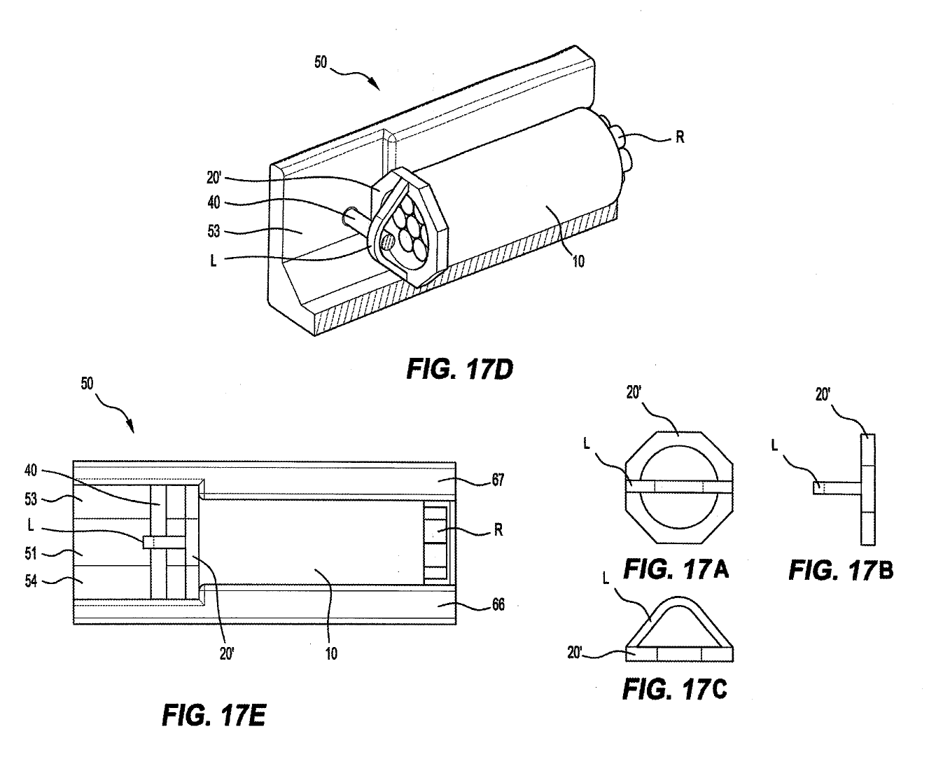

In a first variation, as best shown in FIGS. 17A to 17C, the plate 20′ can be modified to provide it with a lifting and towing lug L at the wire rope end. The lug L comprises a looped section of plate that is welded W onto the plate 20′. The lug L provides a means of lifting and towing the ferrule and associated wire rope into place during installation in a socket. The loop of the lug can receive therethrough the shank of bolt 40 (see FIGS. 17D and 17E). However, the loop of the lug can also accommodate (i.e. receive therethrough) the anti-hammering locking assembly embodiment that is described below with reference to FIG. 15.

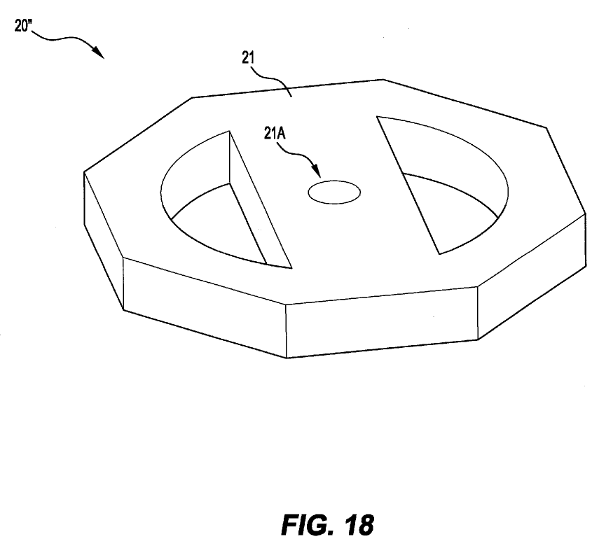

A second variation of the plate 20″ is shown in FIG. 18. This variation can be better suited to a ferrule that is to be locked with other of the anti-hammering locking assembly embodiments as described below with reference to FIGS. 1 to 4, 13, 14 and 16. Further, it has been noted that a permanently welded towing lug L (such as shown in FIG. 17) may cause interference at the wire rope end when, for example, it is being inserted through dump blocks.

Thus, in the plate variation shown in FIG. 18, the plate 20″ is adapted to have an eye bolt releasably attached thereto (i.e. instead of the lug L). In this regard, to releasably attach the eye bolt the plate 20″, a cross member 21 is formed into the plate 20″. In the center of cross member 21, an internally threaded hole 21A is formed. The hole 21A is configured to releasably attach therein an externally threaded shank of the eye bolt, to releasably attach the eye bolt to the plate 20″.

In this regard, the eyebolt can be attached to plate 20″ when towing the rope R. The eyebolt may also better facilitate insertion of the wire rope end through a dump block, etc. (or it may be removed). However, once the rope is in place in or adjacent to the socket, the eyebolt can be removed.

In FIGS. 1 to 5, 17 and 18, the plate 20 is provided with a polygon-shaped profile in the form of an octagon. The plate 20 may be flame-cut or machined from metal plate, such as steel, to have the polygon-shaped profile. In side elevation, the plate 20 defines a squat cylindrical section (e.g. it is not overly and unnecessarily thick). However, the polygon-shaped profile can, for example, be provided with other even numbers of sides (e.g. four, six, ten, etc.). In this case, it may be square, rectangular, diamond-shaped, rhombus- or trapezoidal-shaped, or hexagonal, decahedron, etc. The plate may even have an uneven number of sides (e.g. five, seven, nine, etc.).

The plate 20 of FIGS. 1 to 5 and 17 is provided with a central opening in the form of a hole 22 therethrough (e.g. that is pre- or post-formed through the plate). As best shown in FIG. 5, the hole 22 has a diameter that generally corresponds to the diameter of the wire rope at the distal end of the ferrule 10. Thus, any protruding wire rope at the ferrule distal end can be received in, and be accommodated and protected by the plate 20 (i.e. the plate 20 surrounds such protruding wire as shown in FIG. 5).

In one embodiment of the socket 50, when the cavity 51 is unmodified, the plate 20 is modified to interact just with the opposing internal walls 53 and 54 of the socket cavity 51 (see FIG. 5). In this regard, the wall formations 55, 56 and 58 of the socket 50 shown in FIG. 5 may not require modification, and the sides 26, 27 and 28 shown in FIG. 5 of plate 20 may be modified accordingly.

However, as shown in FIG. 5, five sides of the octagon-shaped profile of the plate 20 can be configured to mate with a corresponding formation within the socket cavity 51 in use. In particular, two opposing sides 23 and 24 of the octagon-shaped profile can mate (e.g. closely face or abut) in use with opposing internal walls 53 and 54 of the socket cavity 51. In addition, lower side 26, and a portion of each of the sides 27 and 28 of the octagon-shaped profile, can mate (e.g. closely face or abut) with angled walls 55 and 56, and base 58 of the socket 50. This configuration maximizes keying-in of the ferrule in socket cavity 51.

The plate 20 is also typically configured such that the distance between opposing sides (e.g. sides 23 and 24) in the polygon-shaped profile is equal to or greater than a diameter of the ferrule at the distal end 14, so that preferentially the plate 20, rather than the ferrule, interacts with the socket walls (e.g. opposing walls 53 and 54).

To prevent the ferrule 10 from shifting or shunting forward axially in the socket cavity 51 in use (i.e. to provide an anti-hammering function and to prevent ferrule fall out of the socket), a locking assembly can be employed. A number of different locking assembly embodiments are shown in FIGS. 1 to 4, and 13 to 16.

A first locking assembly embodiment is shown in FIGS. 1 to 4 and takes the form of a number of locking components. These locking components can be used with the ferrules 10, 100, 200, 400 and the sockets 50, 120, 220, 520 (described below).

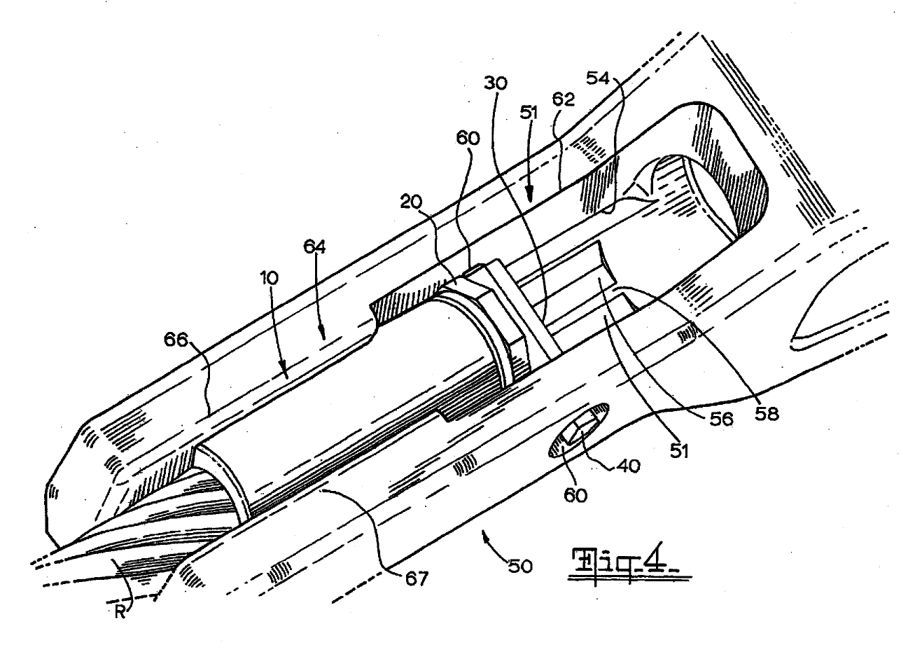

In the locking assembly embodiment of FIGS. 1 to 4, the locking components include a locking block 30 that is able to be positioned and secured in the socket cavity 51 adjacent to the plate 20 at the distal end 14 of the ferrule 10, as best shown in FIG. 4. The locking block 30 can be dropped into the socket so as to freely locate adjacent to the plate 20. Alternatively, the locking block 30 can be secured to the plate 20 (e.g. releasably by bolts, grub screws, or permanently by welding, etc.). In this alternative option, the locking block 30 can be secured to the plate 20 prior to or once located in the socket cavity 51.

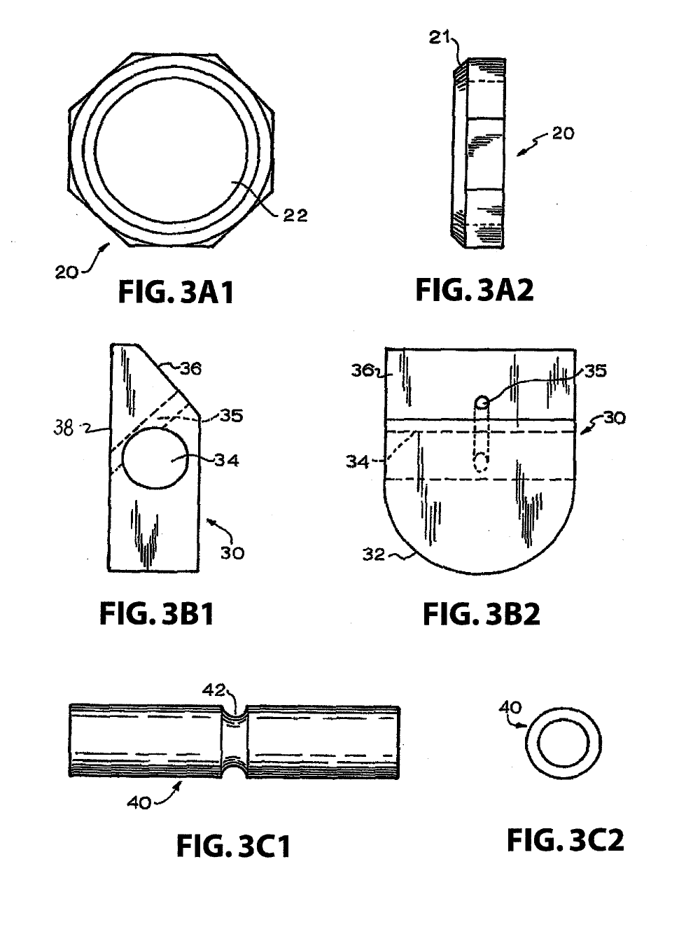

The locking block 30 has a curved base 32 that can abut with angled walls 55 and 56, and base 58 of the socket 50. The locking block 30 also has a transverse bolt hole 34 extending therethrough, and an angled spring-pin hole 35 that extends downwardly therein from a rear angled face 36 of the block 30 to partially intersect with bolt hole 34 (FIGS. 3B1 and 3B2). The spring-pin hole 35 can receive a spring-loaded retention pin 37 therein (FIGS. 2A and 2B). The locking block 30 also has a major face 38 (FIG. 3B1) which when the locking block 30 is received in the socket 50 (FIG. 4) faces the end of the ferrule 10 to secure the ferrule 10 in the socket 50.

The locking components can also include a bolt 40 for extending through the transverse bolt hole 34 that extends through the locking block 30. The bolt includes a spring pin retention groove 42 intermediate its ends. When the retention pin 37 extends through the spring-pin hole 35 of the block 30, a portion of the pin protrudes into bolt hole 34 (FIG. 2A), and this portion can locate in and engage with the groove 42 of bolt 40 to secure the bolt to the locking block 30 in use. This in turn secures the locking block 30 to the socket 50.

In this regard, and as best shown in FIG. 4, when opposing holes 60 of the socket 50 are aligned with bolt hole 34 of locking block 30, the bolt 40 can be inserted from one side of the socket though a hole 60, through aligned bolt hole 34, and though an opposing hole 60 at an opposite side of the socket to secure the locking block to the socket in use. The holes 60 are typically pre-existing (i.e. already present in the socket).

FIG. 4 also shows that cavity 51 comprises wider and narrower sections 62 and 64 respectively. The ferrule 10 can initially be dropped into the wider cavity section 62, and can then be pulled back axially to locate under and be retained by overlying opposed lips 66, 67 of the narrower cavity section 64. This configuration can also be present in sockets 120, 220 and 520.

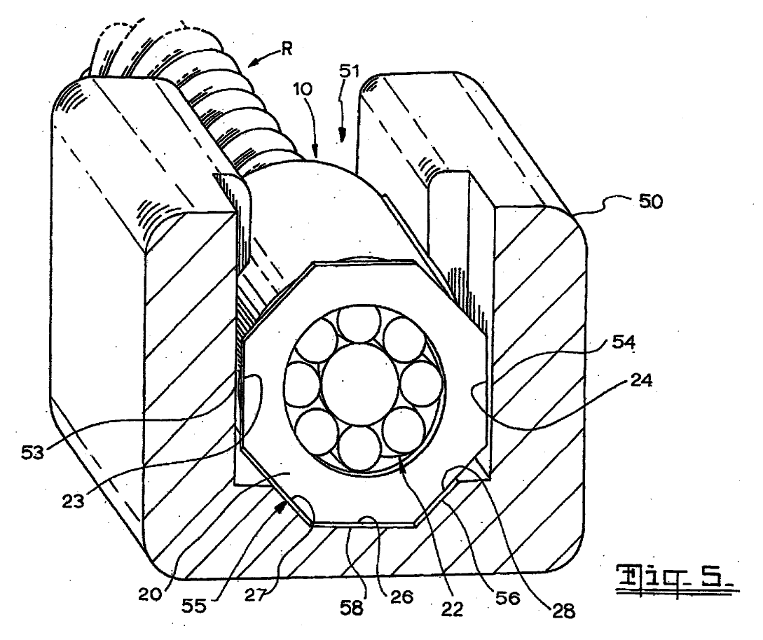

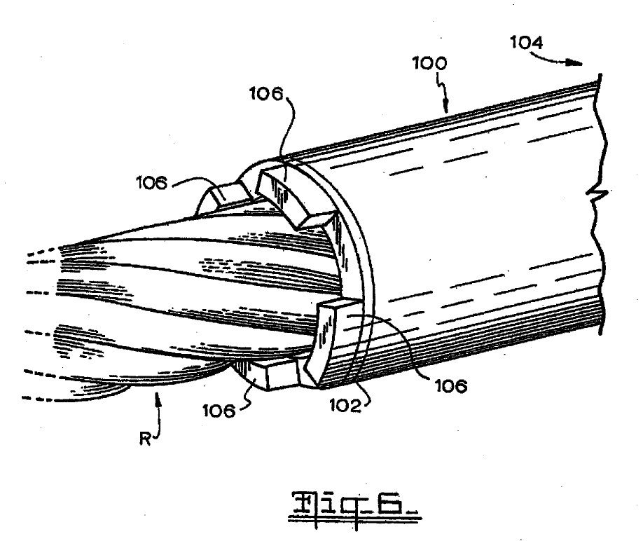

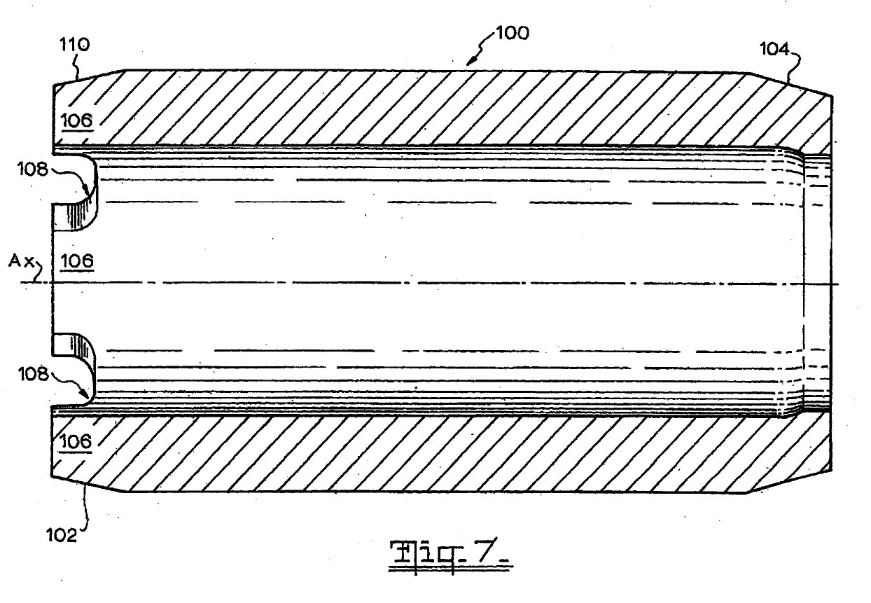

Referring now to FIGS. 6 to 9 a ferrule 100 for attachment to an end of a wire rope R is shown. The ferrule 100 comprises an open proximal end 102 into which the end of the wire rope can be received for securement in the ferrule. The ferrule 100 also comprises an opposing distal end 104. The ferrule 100 in FIGS. 7 and 8 is shown in its “undeformed” configuration, namely, prior to being die-pressed onto the wire rope as in FIGS. 6 and 9.

In FIGS. 6 to 9, the ferrule 100 is now configured around the proximal end 102 for mating engagement with a socket 120. The socket 120 has a modified cavity in which the ferrule can be received, with a corresponding formation in the cavity mating with the ferrule in use. Again, this mating engagement can occur for a given one of a number of rotational orientations of the ferrule around its axis Ax.

In this regard, the ferrule is provided with a series of (e.g. four equidistant) spaced, discrete lugs 106 at the proximal end 102. The lugs 106 project to define a castellated profile at the proximal end. As shown in FIG. 8, the circumferential sweep of each lug 106 is 45°. Such a configuration can be easily formed at the ferrule open end such as by machining, cutting (e.g. flame cutting), etc.

A radius 108 is provided on either side of each ferrule lug 106 where it is connected to a remainder of the ferrule 100. These radii can ensure material integrity, in the transition from the ferrule lug to a remainder (or body) of the ferrule, so that there is no point of weakness at this location. Such weakness could otherwise result in ferrule failure when it is being secured to the wire rope or in use.

Prior to die-pressing the ferrule onto the end of a wire rope, an outwardly facing surface of each ferrule lug 106 may be chamfered 110 (FIG. 7). The chamfer extends beyond the lug and into the body of the ferrule. The chamfer 110 on each lug can function to assist with the preservation of a consistent shape of the ferrule 100 after it has been die-pressed onto a wire rope.

As best shown in FIG. 9, the socket 120 is modified by providing it with corresponding socket lugs 122. Each socket lug 122 is arranged to locate between adjacent respective ferrule lugs 106 when the ferrule 100 is located in the socket cavity 124 in use. In addition, a dovetail recess 126 is defined between each socket lug and into which recess a respective ferrule lug 106 locates in a dovetail fit.

Such a configuration has been observed to provide very effective mating to stop the ferrule 100 from rotating or twisting within the socket cavity 124, and to allow torque from the wire rope to be on-transferred to the socket.

Whilst the ferrule 100 is shown with four lugs 106 spaced equidistantly from each adjacent lug at and around the proximal end, other permutations are possible. For example, as little as a single lug may be sufficient, or e.g. up to six lugs may be employed. The number of socket lugs and/or recesses is then adjusted accordingly.

Each of the different locking assembly embodiments of FIGS. 1 to 4, and 13 to 16 can be employed to prevent the ferrule 100 from shifting or shunting forward axially in the socket cavity 124 in use (i.e. to provide an anti-hammering function and to prevent ferrule fall out of the socket).

Referring now to FIGS. 10 and 11, a ferrule 200 for attachment to an end of a wire rope R is shown. The ferrule 200 in FIG. 10 is shown in its “undeformed” configuration, namely, prior to being die-pressed onto the wire rope as in FIG. 11.

The ferrule 200 comprises an open proximal end 202 into which the end of the wire rope can be received for securement in the ferrule. The ferrule 100 also comprises an opposing distal end 204.

In FIGS. 10 and 11, the ferrule 200 is again configured around the proximal end 202 for mating engagement with a socket 220. The socket 220 has a modified cavity in which the ferrule 200 can be received, with a corresponding formation in the cavity mating with the ferrule in use. Again, this mating engagement can occur for a given one of a number of rotational orientations of the ferrule around its axis.

In this regard, the ferrule is provided with a series of (e.g. four equidistant) spaced, discrete lugs 206 at the proximal end 202. Again, the lugs 206 project to define a castellated profile at the proximal end. However, in this embodiment, the side walls 207 of each lug are parallel. In addition, the side walls 207 of opposing lugs 206 align. Again, such a configuration can be easily formed at the ferrule open end such as by machining, cutting (e.g. flame cutting), etc.

In this embodiment a radial groove 208 is provided on either side of each ferrule lug 206 where it is connected to a remainder of the ferrule 200. These radial grooves can ensure that there is no point of weakness at this location, which could otherwise result in ferrule failure when it is being secured to the wire rope or in use.

Again, prior to die-pressing the ferrule onto the end of a wire rope, an outwardly facing surface of each ferrule lug 206 may be chamfered 210, with the chamfer extending beyond the lug and into the body of the ferrule. Again, the chamfer 210 on each lug can function to assist with the preservation of a consistent shape of the ferrule 100 after it has been die-pressed onto a wire rope.

As shown in FIG. 11, the socket 220 is modified by providing it with corresponding socket lugs 222. Each socket lug 222 is arranged to locate between adjacent respective ferrule lugs 206 when the ferrule 100 is located in the socket cavity 124 in use. In addition, a “square-sided” recess 226 is defined between each socket lug and into which recess a respective ferrule lug 206 locates in a square fit (i.e. the side walls 207 closely face respective adjacent sides of each recess 226).

Again, such a configuration has been observed to provide very effective mating to stop the ferrule 200 from rotating or twisting within the socket cavity 224, and to allow torque from the wire rope to be on-transferred to the socket.

Again, whilst the ferrule 200 is shown with four lugs 206 spaced equidistantly from each adjacent lug at and around the proximal end, other permutations are possible.

Each of the different locking assembly embodiments of FIGS. 1 to 4, and 13 to 16 can be employed to prevent the ferrule 200 from shifting or shunting forward axially in the socket cavity 224 in use (i.e. to provide an anti-hammering function and to prevent ferrule fall out of the socket).

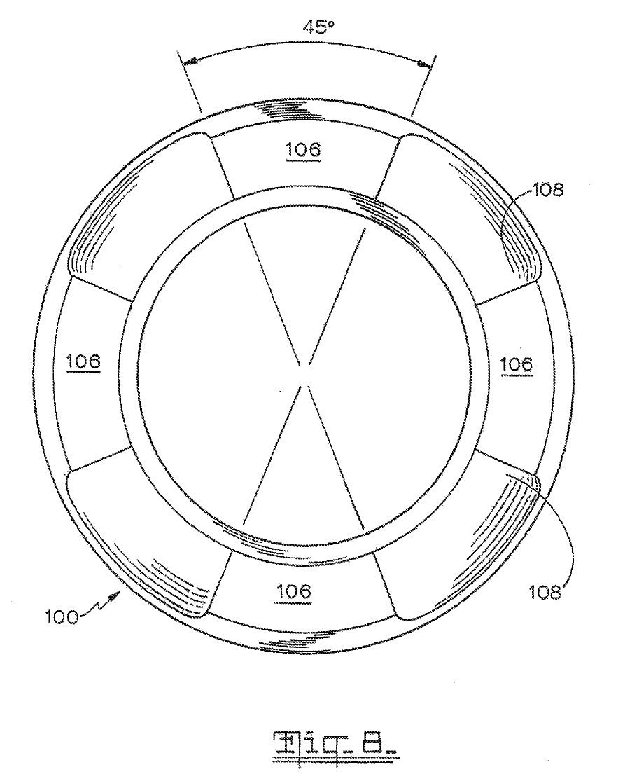

Referring now to FIG. 12, a ferrule 400 attached to an end of a wire rope R is shown. The wire rope R is shown having already been received and secured in the open proximal end 402 of ferrule 400. The ferrule 400 also comprises an opposing distal end 404 that is configured for mating engagement with a socket. The socket may or may not require a modified cavity into which the ferrule 400 is to be received.

The ferrule 400 is provided with a U-shaped plate 406, typically welded at its distal end 404. The plate 406 can be easily formed such as by machining, cutting (e.g. flame cutting), etc. Part of an internal edge of the plate 406 may be chamfered or beveled to assist with the welding of the plate onto the ferrule distal end 404.

Opposing sides 407 and 408 of the plate 406 are spaced so as to abut (e.g. interferingly) with correspondingly spaced internal and opposing side walls of the socket. For example, the ferrule distal end 404 may be hammered at upper flat edge 410, or otherwise jammed into the socket, by a suitable tool, to thereby secure the ferrule 400 thereto, thus enabling torque translation between the ferrule and socket.

Each of the different locking assembly embodiments of FIGS. 1 to 4, and 13 to 16 can be employed to prevent the ferrule 400 from shifting or shunting forward axially in the socket cavity in use (i.e. to provide an anti-hammering function and to prevent ferrule fall out of the socket).

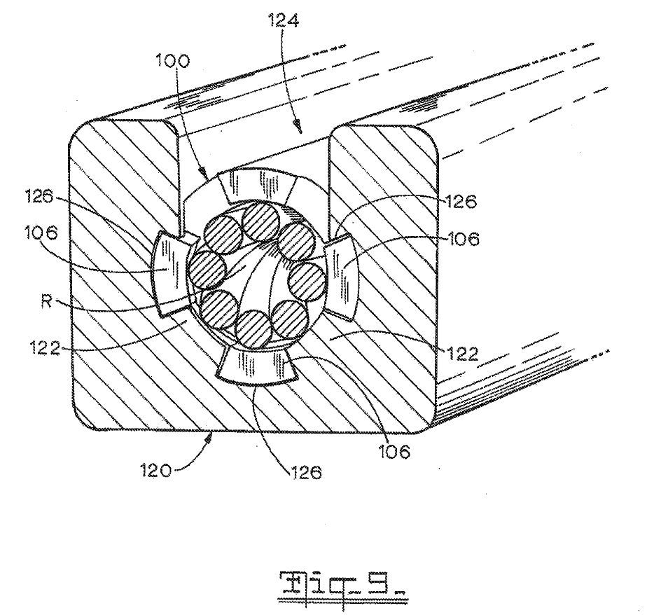

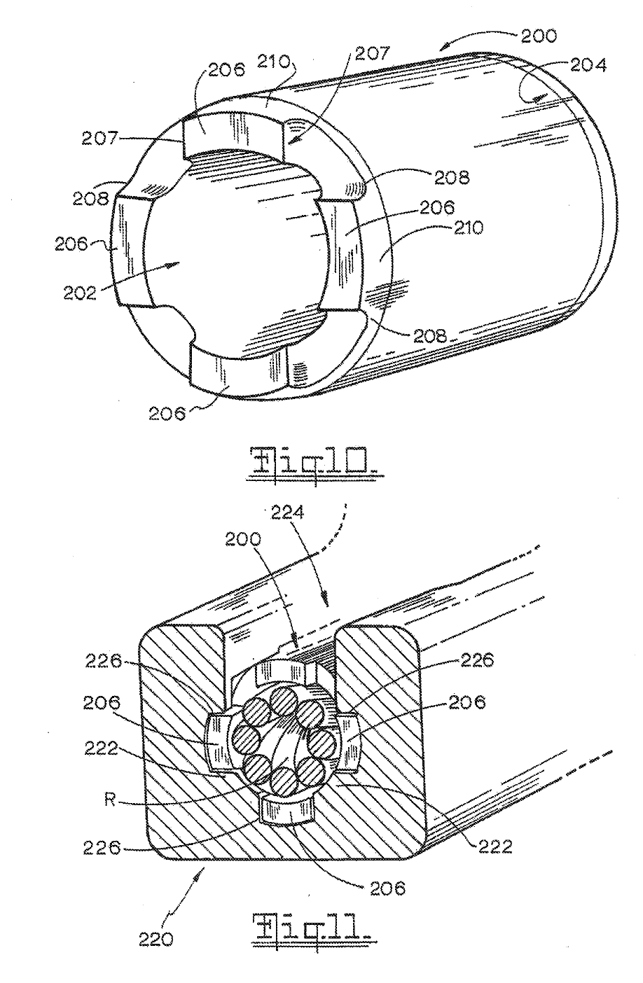

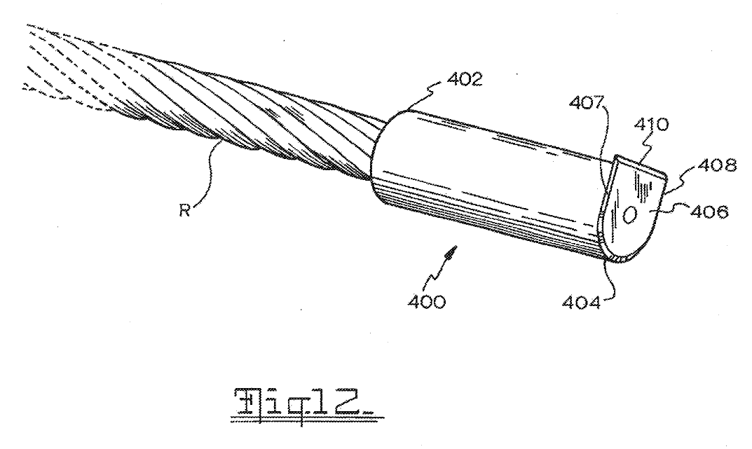

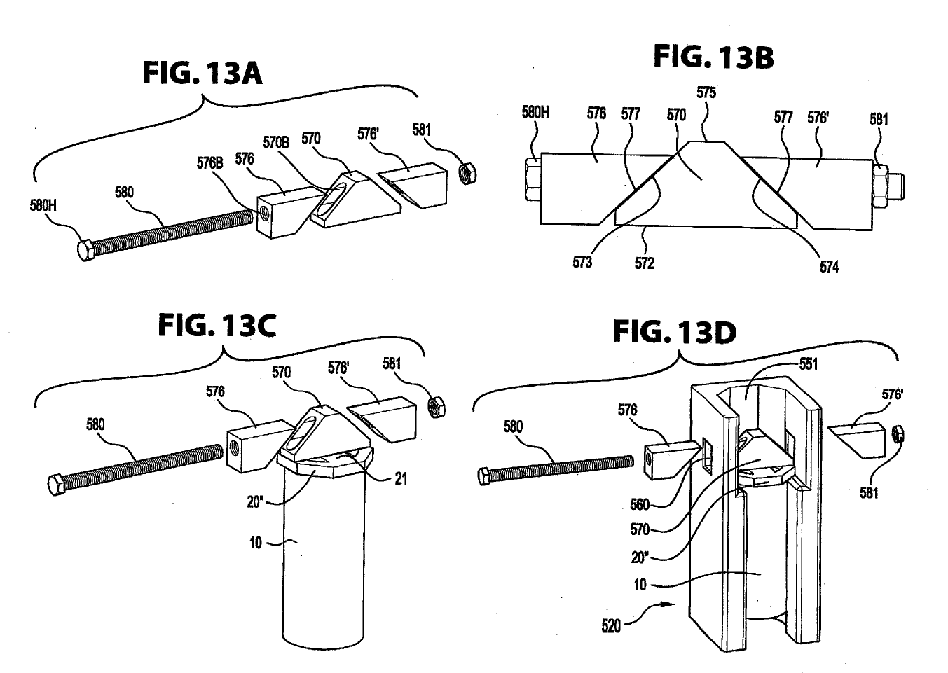

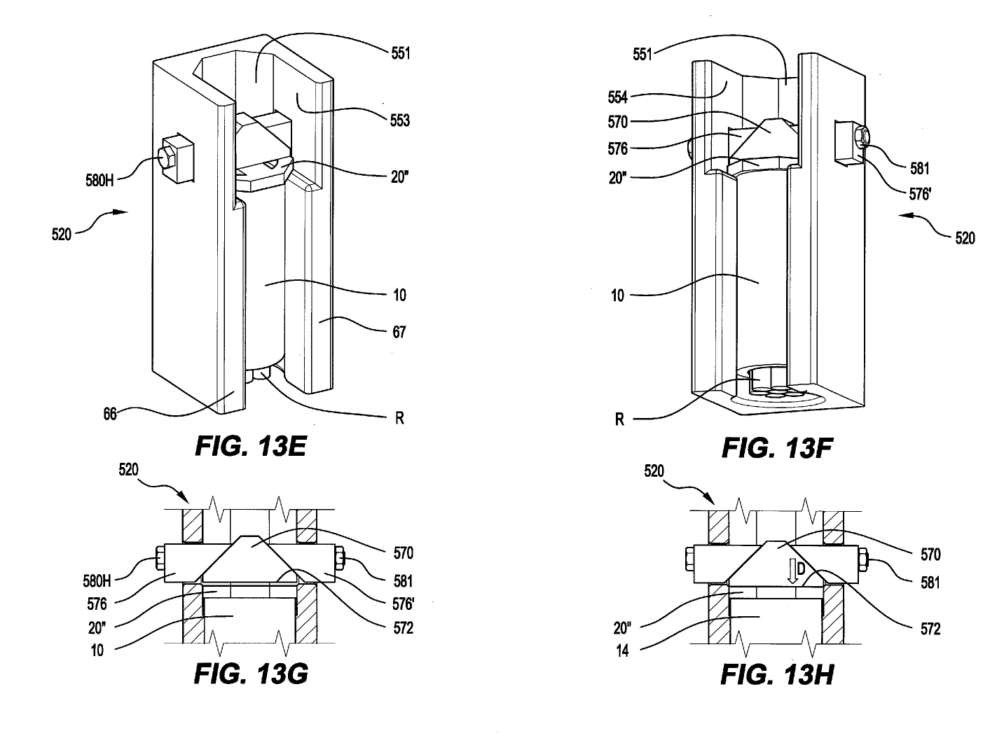

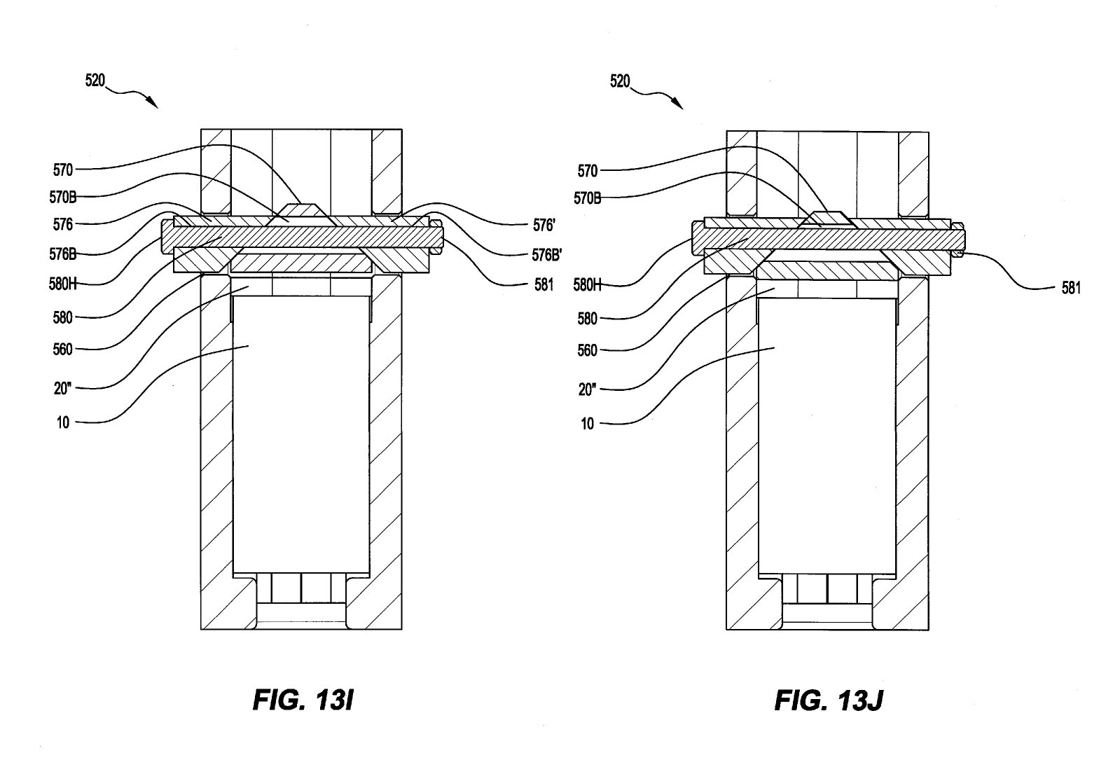

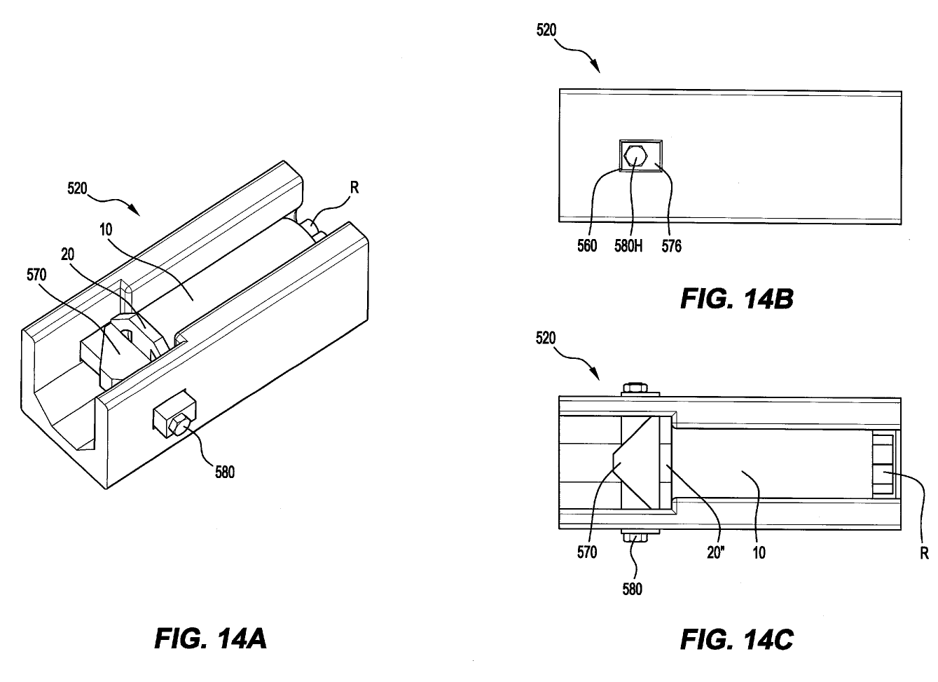

Referring now to FIGS. 13 and 14, where like reference numerals to FIGS. 1 to 5 are used to denote similar or like parts, a second locking assembly embodiment is shown for securing in a socket 520 a ferrule 10 that is attached to a wire rope R (i.e. the end of the wire rope has been received through and secured in the open end 12 of the ferrule). The socket 520 may have a clevis defined at the socket end that is opposite to where the wire rope enters the socket. The clevis enables the socket to be coupled into a dragline hoist and/or rigging assembly.

The distal end 14 of ferrule 10 is provided with an octagonal mating plate 20″ for mating engagement with suitable walls 553 and 554 of the modified socket cavity 551 (FIGS. 13E & 13F). Again, this mating engagement can occur for a given one of a number of rotational orientations of the ferrule around its axis Ax.

However, in the locking assembly embodiment of FIGS. 13 and 14, one of the locking components takes the form of a trapezoidal prism 570. As best shown in FIG. 13H, a major face 572 of the prism 570 can in use be displaced (arrow D) into engagement with the plate 20″ affixed to the end 14 of the ferrule 10 to secure the ferrule in the socket cavity 551 of socket 520 (i.e. to prevent forward shifting/shunting and thus hammering of the ferrule in the socket). To enable its displacement, the trapezoidal prism comprises angled faces 573, 574 located on either side thereof. The angled faces 573, 574 extend from the major face 572 and converge to an opposing minor face 575.

In the locking assembly embodiment of FIGS. 13 and 14, other of the locking components comprise respective drive elements 576 and 576′ located laterally and on opposite sides of the trapezoidal prism 570. Each drive element comprises an angled side face 577 that in use is positioned to engage a respective one of the angled faces 573, 574 of the trapezoidal prism 570.

In a typical configuration, the overall height of the trapezoidal prism 570 is made to be greater than the drive elements 576 and 576′. This enables the prism 570 to have more “travel” when drive by the drive elements (i.e. a greater extent of displacement, such as up to 15-18 mm in a typical dragline hoist socket). Because of this greater height/size, trapezoidal prism 570 is installed separately to the drive elements 576 and 576′. As shown in FIG. 13D, the drive elements 576 and 576′ are installed through and located within a respective square hole 560 on either side of the socket, whereas the prism 570 is installed via the socket cavity 551 of socket 520. The greater height of the trapezoidal prism 570 also prevents the locking components from spinning around in the socket cavity 551 of socket 520 in use.

As also shown in FIGS. 13A to 13D, a bolt 580 extends through the opposing holes 560 of the socket 520, which holes also snugly receive and slidingly support, but for back-and-forth transverse movement only, the drive elements 576 and 576′.

As best shown in FIGS. 13I and 13J (which are cross-sectional plan views taken through the socket 520 and the drive elements 576 and 576′ and trapezoidal prism 570), a shank of the bolt 580 is extends in a snug manner through aligned bores 576B and 576B′ of the drive elements 576 and 576′. The shank of the bolt 580 also extends through a bore 570B of the trapezoidal prism 570. However, bore 570B is enlarged on either side along its length, and relative to the drive element bores 576B and 576B′. This enlarging allows the prism 570 to be displaced relative to the drive elements 576 and 576′, when the latter are caused to be displaced inwardly within holes 560 of socket 520.

A nut 581 is secured to the bolt 580, adjacent to the drive element 576′, with a bolt head 580H locating adjacent to the other of the drive elements 576. Thus, the drive element side faces 577 are held in proximity of the trapezoidal prism angled faces 573, 574 by the nut and bolt assembly.

In use, as the nut 581 is caused to be moved inwards of the bolt 580 (i.e. by a suitable tool), the drive elements 576 and 576′ are caused to slide towards each other, sliding in along the bolt and within a respective passage defined by their respective square hole 560. The side faces 577 respectively engage and act on each trapezoidal prism angled face 573, 574. This in turn causes the trapezoidal prism 570 to be displaced (D) within the socket towards the ferrule 10, until the prism major face 572 is brought into engagement with (i.e. abuts) the plate 20″ affixed at end 14 of the ferrule 10 (see FIGS. 13H and 13J). In this position, the trapezoidal prism 570 lockingly secures the ferrule 10 in the socket cavity 551 of socket 520, thereby preventing ferrule shunting and hammering within the socket in use.

To release the ferrule 10, the bolt 580 and nut 581 are removed, and each of the drive elements 576 and 576′ is removed from its respective square hole 560, and the trapezoidal prism 570 is removed from the socket cavity 551.

Referring now to FIG. 15, a third locking assembly embodiment is shown for securing a ferrule (such as a ferrule 10 attached to a wire rope R) in a socket. In FIG. 15 only the octagonal mating plate 20 of ferrule 10 is shown (i.e. the wire rope and socket are not shown, but are similar to that shown in FIGS. 13 and 14).

In the locking assembly embodiment of FIG. 15, the locking component takes the form of a cam element, the latter which takes the form of an elongate tube 630 having an elliptical profile (see FIGS. 15B and 15C). The tube 630 extends transversely in the socket in use (i.e. in much the same way as trapezoidal prism 570). The elongate tube 630 functions as an in-use transversely extending elongate cam element.

The elliptical profile of tube 630 defines active external surfaces 631 and 632 on opposing ends of the ellipse, the active surfaces extending for the full length of the tube. The elliptical profile of tube 630 also defines passive external surfaces 634 and 635, located on opposing sides of the ellipse and extending for the full length of the tube.

As shown in FIG. 15B, the passive surfaces 634 and 635 are each configured in use so as not to engage with plate 20 (i.e. with the plate when affixed to end 14 of ferrule 10 when located in a socket). However, as shown in FIG. 15C, the active surfaces 631 and 632 are each configured for engaging with the octagonal mating plate 20 in use.

In this regard, at a certain rotational orientation of the tube 630, one of the active surfaces 631 or 632 is brought into engagement with (i.e. to abut) the plate 20 affixed to the ferrule 10 in use. In this rotational orientation, the tube 630 lockingly secures the ferrule 10 in the socket (e.g. within cavity 551 of socket 520), thereby preventing ferrule shunting and hammering within the socket in use.

To enable tube 630 to be rotated so that one of the active surfaces 631 or 632 is brought into engagement with plate 20, a drive bolt 680 is provided to extend through the tube 630 as well as through opposing socket holes (e.g. through holes 560 of the socket 520). The tube 630 and bolt 680 are mutually configured to each other, whereby rotation of the bolt 680 in the socket about the bolt's elongate axis Ab causes the tube 630 to be rotated.

To ensure that one of the active surfaces 631 or 632 remains in engagement with plate 20, opposing ends 681 and/or 683 of the drive bolt 680 can be modified so as to enable them to be fixed with respect to the socket (e.g. at holes 560 of the socket 520), thereby preventing bolt rotation. For example, a head of the bolt may move into a suitable recess at 560 once one of the active surfaces 631 or 632 has engaged with plate 20, and may be maintained therein by tightening a nut at the opposite end of the bolt. Alternatively, each end of the bolt may have a tightening nut supplied thereat to hold the bolt in that rotational orientation. In a further alternative, a bayonet coupling may be provided at one end of the bolt, the bayonet coupling engaging at 560 when one of the active surfaces 631 or 632 has engaged with plate 20.

In this regard, the tube 630 comprises a square-profiled elongate bore 636 extending therethrough. In addition, the bolt 680 comprises a length 682 of its shank that is correspondingly square shaped to locate snugly within the bore 636. These matching profiles enable close mating of the bolt 680 with the tube 630 when the bolt is rotated (i.e. for accurate translation of rotational movement). However, other (e.g. polygonal) profile shapes of the bore 636 and shank length 682 can be employed.

The tube 630 and bolt 680 combination can also be used with the modified plate 20″ of FIG. 17 that comprises the lifting and towing lug L. In this regard, the tube and lug can each be sized such that the tube freely extends through the loop of the lug in use (i.e. when the ferrule is located in the socket).

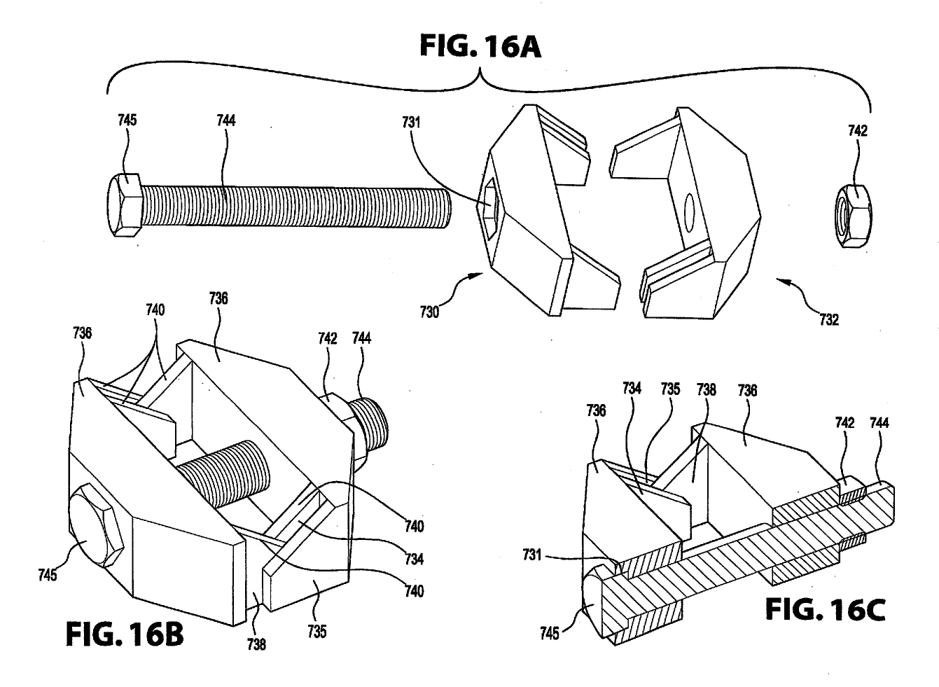

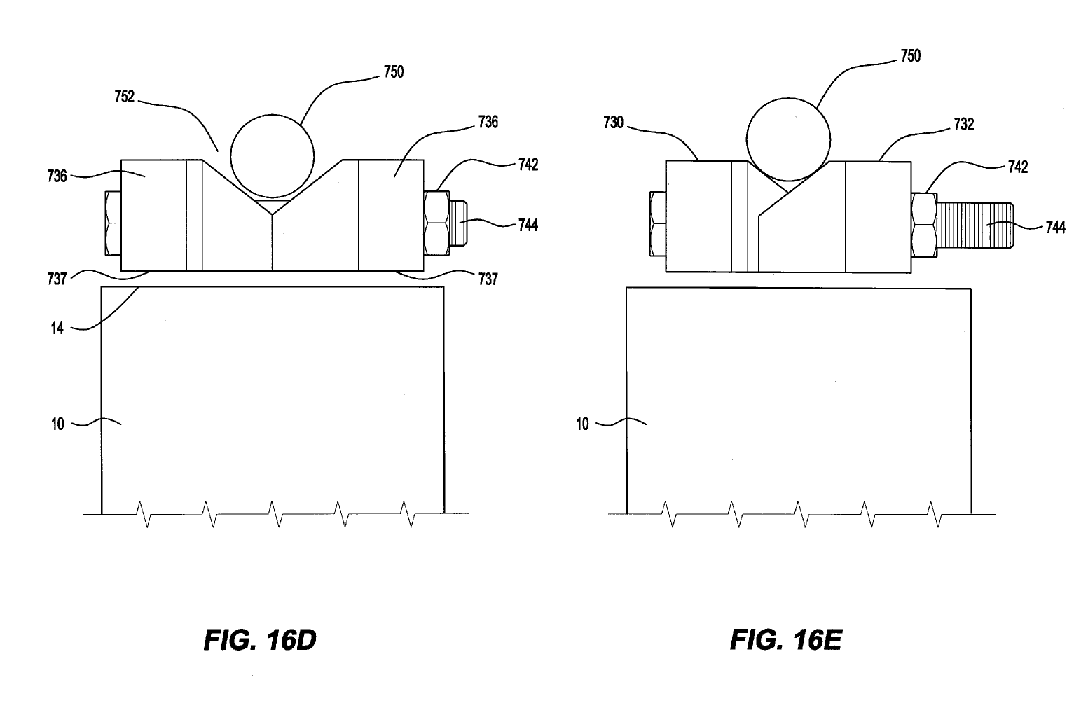

Referring now to FIG. 16, a fourth locking assembly embodiment is shown for securing a ferrule 10 in a socket (the latter not shown, but which socket can be similar to that shown in FIGS. 13 and 14). The ferrule 10 is attached to a wire rope R (also not shown). In the embodiment of FIG. 16 the plate 20 is not provided on the end 14 of ferrule 10. However, the locking assembly may be employed either with or without the plate 20 affixed on the end of ferrule 10.

In the locking assembly embodiment of FIG. 16, locking components are provided which take the form of first and second slidable block parts 730 and 732. The block parts can in use slide back-and-forth towards each other along an axis that is transverse to a longitudinal axis of the socket.

In the locking assembly embodiment of FIG. 16, when the block parts 730 and 732 are slideably moved towards each other, they interact with a socket bolt in the form of a pin 750 (i.e. the pin 750 may, for example, extend through the socket holes 560 of socket 520 and thus be fixed with respect to the socket). This interaction of the block parts 730 and 732 with fixed pin 750 is such as to cause the block parts to be displaced towards and to eventually engage with the end 14 of the ferrule 10, to lockingly secure the ferrule in the socket (see FIG. 16E).

In the embodiment of FIG. 16, the block parts 730 and 732 are, for the most part, identical. The main difference is that block part 730 comprises a recess 731 (see FIG. 16C) that is shaped to retain (and thereby prevent rotation of) a hexagonal bolthead 745 of a connector bolt 744, as described further hereafter.

Each block part 730 and 732 comprises a pair of flanges 734, 735 located at, and so as to extend inwardly in use from, one end of a block body 736. Each part also comprises a single flange 738 located inset from, and so as to extend inwardly in use from, the other end of the block body 736. The single flange 738 of one block part is slideably received between the pair of flanges 734, 735 of the other block part (and vice versa), to support the back-and-forth sliding movement of the block parts.

Each block body 736 comprises a ferrule-engaging underside 737. Further, each of the flanges 734, 735 and 738 of each block part 730 and 732 has an angled face 740 defined along an upper side thereof for engaging with the pin 750, as described hereafter.

The block parts 730 and 732 are connected together by a nut 742 and the connector bolt 744. The nut 742 and connector bolt 744 also act as the drive for the back-and-forth sliding movement of the block parts 730 and 732. In this regard, when the nut 742 is rotated in a given direction on the connector bolt 744, the bolthead 745 resists bolt rotation and hence the block parts 730 and 732 are caused to be moved towards each other (see FIGS. 16D and 16E).

Before the block parts 730 and 732 are moved towards each other, the block parts and pin 750 are arranged such that the pin passes through a passage 752 having a V-shaped profile (see FIG. 16D). This V-shape is defined by the adjacent angled faces 740 of each of the block parts. Once the block parts 730 and 732 are moved towards each other, by rotating the nut 742 in the given direction on the connector bolt 744, the angled faces 740 of each of the block parts come into engagement with the pin 750, whereby the V-shaped passage is made shallower and the block parts 730 and 732 are each caused by the pin to be displaced towards the ferrule end 14 (i.e. due to the action of the fixed pin 750 on faces 740). Eventually the underside 737 of each of the block parts is caused to be brought into engagement with the ferrule end 14 to lockingly secure the ferrule in the socket.

Non-limiting examples will now be described:

### Example 1

A method of securing a ferrule 10 in a socket 50 comprised locating the ferrule so as to mate with the corresponding formation of the socket. In this regard, the ferrule was loaded (e.g. dropped) into the wider cavity section 62 of cavity 51. Usually prior to being so dropped, the ferrule and/or wire rope were first twisted or rotated just a small amount and sufficiently such that two opposing sides (e.g. 23 and 24) of plate 20 aligned with the opposing internal walls (e.g. 53 and 54) of the socket cavity.

The wire rope and/or socket were then pulled (or the ferrule was pushed such as by a tool) so that it moved back axially within cavity 51 to locate in narrower cavity section 64, to be retained under opposed lips 66, 67. The ferrule was now ready to be lockingly secured against axial movement within the socket.

### Example 2

In this example, the ferrule 10 was lockingly secured against axial movement within the socket by the locking block 30. The locking block 30 was dropped into the wider cavity section 62 of cavity 51. Alternatively, the locking block 30 was already pre-secured to the plate 20, so that it loaded into the cavity section 62 of cavity 51 together with the ferrule 10.

In either case, once the bolt hole 34 of block 30 aligned with the opposed socket holes 60, the bolt 40 was extended through the opposed socket holes 60 and bolt hole 34. When the groove 42 of bolt 40 aligned with the spring-pin hole 35, the spring-loaded retaining pin 37 was urged therein, so that part of its shaft located into groove 42. Thus, the block 30 became secured to the bolt 40, and the bolt became secured to the socket 50. The ferrule 10 and thus wire rope R were now securely retained and locked in the socket.

### Example 3

In this example, the ferrule 10 was lockingly secured against axial movement within the socket by the trapezoidal prism 570. The nut 581 was drivingly rotated by a power tool, moving inwards of the bolt 580. The drive elements 576 and 576′ were in turn caused to slide towards each other, whereby their side faces 577 respectively engaged and acted on each trapezoidal prism angled face 573, 574. This caused the trapezoidal prism 570 to be displaced within the socket towards the ferrule 10 until its major face 572 abutted the plate 20 at end 14 of the ferrule 10. The ferrule 10 and thus wire rope R were now securely retained and locked in the socket.

### Example 4

In this example, the ferrule 10 was lockingly secured against axial movement within the socket by the tube 630. A projecting end (e.g. bolt head) of the he bolt 680 was drivingly rotated by a power tool about its axis Ab, causing the tube 630 to be rotated, and so that one of the active surfaces 631 or 632 was brought into frictional abutment with plate 20. The ferrule 10 and thus wire rope R were now securely retained and locked in the socket.

The tube 630 and bolt 680 combination were also used with the modified plate 20″ of FIG. 17 by freely inserting both the tube and bolt through the lug L. Again, when the bolt 680 was rotated about its axis Ab, the tube 630 was rotated and one of its active surfaces 631 or 632 was brought into frictional abutment with plate 20″.

### Example 5

In this example, the ferrule 10 was lockingly secured against axial movement within the socket by the block parts 730 and 732. In this regard, the nut 742 was rotated in the given direction on the connector bolt 744, causing the block parts 730 and 732 to slide towards each other, whereby the angled faces 740 of each block part began to engage with the pin 750. This caused the block parts 730 and 732 to start displacing towards the ferrule end, until the underside 737 of each block part abutted the ferrule end. The ferrule 10 and thus wire rope R were now securely retained and locked in the socket.

### Example 6

A method of securing a ferrule 100 or 200 in a socket 120 or 220 again comprised locating the ferrule so as to mate with the corresponding formation of the socket. In this regard, the ferrule was again loaded (e.g. dropped) into the wider cavity section of cavity 124 or 224 of socket 120 or 220. Usually prior to being so dropped, or once initially located in the socket, the ferrule and/or wire rope were twisted or rotated just a small amount and sufficiently such that adjacent lugs 106 or 206 could be aligned with (i.e. to locate on either side of) the opposing socket lugs 122 or 222 within the socket cavity 124 or 224.

The wire rope and/or socket were then pulled (or the ferrule was pushed such as by a tool) so that it moved back axially within cavity 124 or 224 to locate in narrower cavity section, to be retained under opposed lips, and so that the lugs 106 or 206 and 122 or 222 intermeshed.

The ferrule 100 or 200 was then secured against axial movement within the socket 120 or 220. In this regard, the locking block 30, spring-pin 37 and locking bolt 40 were employed in a similar manner to Example 1.

The various components of Examples 1 to 6 were observed to be easy to use, robust, reliable and strong. The various locking assembly components were able to secure and robustly lock the ferrule in the socket cavity of a socket, thereby preventing ferrule shunting and hammering within the socket in use.

Whilst specific embodiments of a locking assembly and socket have been described, it should be appreciated that the locking assembly and socket may be embodied in other forms.

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the locking assembly and socket as disclosed herein.

The invention claimed is:

1. A dragline socket locking assembly for locking a dragline ferrule attached to an end of a wire rope in a dragline socket into which the ferrule can be received in use, the locking assembly comprising a drop in locking block that is positioned and received in the socket adjacent to a distal end of the ferrule, the locking block comprising a major face which, when the locking block is received in the socket in use, faces the end of the ferrule to secure it in the socket.

2. The locking assembly as claimed in claim 1 further comprising a bolt for extending through aligned holes or passages of the locking block and socket.

3. The locking assembly as claimed in claim 1, wherein once the locking block has been dropped into the socket, the bolt is adapted to extend from one side of the socket, though a hole at that side, through the aligned hole of the locking block and though an opposing hole at an opposite side of the socket to secure the locking block to the socket in use.

4. The locking assembly as claimed in claim 3, wherein a retention pin is provided to extend from a face opposite to the major face, through the locking block and into engagement with the bolt to secure the bolt to the locking block in use.

5. The locking assembly as claimed in claim 1, the assembly being adapted for locking into the socket wherein the ferrule has a component secured thereto such that the ferrule is able to mate with a corresponding formation of the socket when received in the socket in use.

6. The locking assembly as claimed in claim 5, the locking assembly being operable such that the ferrule is first arranged in the socket in the mating engagement prior to locking the ferrule in the socket with the locking assembly.

7. The locking assembly as claimed in claim 5, wherein the ferrule is configured to mate with the corresponding formation of the socket for multiple rotational orientations of the ferrule around an elongate axis of the ferrule.

8. The locking assembly as claimed claim 1, wherein the locking block is configured to be positioned and secured in the socket adjacent to a component that is secured to the end of the ferrule.

9. The locking assembly as claimed in claim 8, wherein the component has a polygon-shaped or U-shaped profile wherein at least two opposing sides of the profile are configured to mate with a corresponding formation in the socket in use.

10. The locking assembly as claimed in claim 9, wherein the polygon-shaped profile of the component has an even number of sides.

11. The locking assembly as claimed in claim 1, further including a tow lug affixed or releasably secured with respect to the distal end of the ferrule.

12. The locking assembly as claimed in claim 1, wherein the wire rope is for use in a dragline.

13. The socket configured for use with a locking assembly as claimed in claim 1.

14. The socket as claimed in claim 13 that forms part of a dragline hoist and/or rigging assembly.

15. A method of securing a ferrule in a socket, the method comprising:
locating the ferrule so as to mate with the corresponding formation of the socket; and
securing the ferrule against axial movement within the socket using a locking assembly as claimed in claim 1.

16. A system for securing a ferrule in a socket, the system comprising:
a socket;
a ferrule;
the socket comprising a corresponding formation to mate with the ferrule; and
a locking assembly as claimed in claim 1.

17. The locking assembly as claimed in claim 1 wherein the locking block comprises one or more side surfaces that can abut with walls and a base of the socket to restrict rotation of the locking block in the socket.

18. The locking block assembly as claimed in claim 8 wherein the locking block is configured to engage the component in use.

19. The locking assembly as claimed in claim 18 wherein the component comprises a tow lug affixed or releasably secured with respect to the distal end of the ferrule.
